(19) United States
(12) Patent Application Publication
(10) Pub. No.: US 2008/0184041 A1
(43) Pub. Date: Jul. 31, 2008

(54) Graph-Based Tamper Resistance Modeling For Software Protection

(75) Inventors: Mariusz H. Jakubowski, Bellevue, WA (US); Ramarathnam Venkatesan, Redmond, WA (US); Nenad Dedic, Somerville, MA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/694,695

(22) Filed: Mar. 30, 2007

Related U.S. Application Data
(60) Provisional application No. 60/887,432, filed on Jan. 31, 2007.

(51) Int. Cl. G06F 11/30

(52) U.S. Cl. 713/194; 726/22

(57) ABSTRACT

Implementation of graph-based tamper resistance modeling for software protection is described. In one implementation, paths of execution of a program are modeled as a graph having nodes and edges. A tamper resistance tool receives an input program code corresponding to the program and generates a tamper-resistant program code using integrity checks. Values for the integrity checks are computed during program execution and are compared to pre-computed values to determine whether a section of the program has been tempered with. Values of the integrity checks may be accessed at any point in time during execution of the program.

### RELATED PATENT APPLICATIONS

This U.S. patent application claims the benefit of priority from, and hereby incorporates by reference the entire disclosure of, co-pending U.S. Provisional Application for Letters Patent Ser. No. 60/887,432 filed Jan. 31, 2007, and titled “Graph-Based Tamper Resistance Modeling for Software Protection”.

### BACKGROUND

Proprietary software often needs to be protected from reverse-engineering, pirating, and tampering by persons who desire to undermine the integrity of the software's operation. Even programs for software monitoring, such as copy protection, software licensing, and Digital Rights Management (DRM) applications require protection of crucial code and data, particularly at runtime.

By understanding the operation of a program, hackers are able to access the underlying program code and make unauthorized changes to the program. These changes can include subversion of license checks, the inclusion of viruses into the program code, and the removal of protection from various files with which the program interacts, including audio and video files.

### SUMMARY

Implementation of graph-based tamper resistance modeling for software protection is described. In one implementation, paths of execution of a program are modeled as a graph having nodes and edges. A tamper resistance tool receives an input program code corresponding to the program and generates a tamper-resistant program code using integrity checks. Values for the integrity checks are computed during program execution and are compared to pre-computed values to determine whether a section of the program has been tampered with. Values of the integrity checks may be accessed at any point in time during execution of the program.

Moreover, a minimum time required by hackers to effectively tamper with the tamper-resistant program code can be calculated based on the quantity and/or placement of integrity checks into the tamper-resistant program.

This summary is provided to introduce a selection of concepts in a simplified form that is further described below in the detailed description. This summary is not intended to identify key features or essential features of the claimed subject matter, nor is it intended to be used as an aid in determining the scope of the claimed subject matter.

### BRIEF DESCRIPTION OF THE CONTENTS

The detailed description is described with reference to the accompanying figures. In the figures, the left-most digit of a reference number identifies the figure in which the reference number first appears. The use of the same reference numbers in different figures indicates similar or identical items.

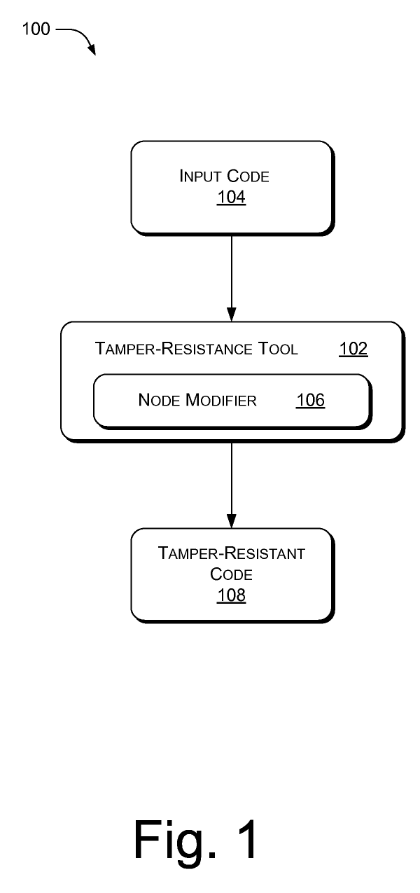

FIG. 1 illustrates an exemplary environment in which graph-based tamper resistance modeling for software protection may be implemented.

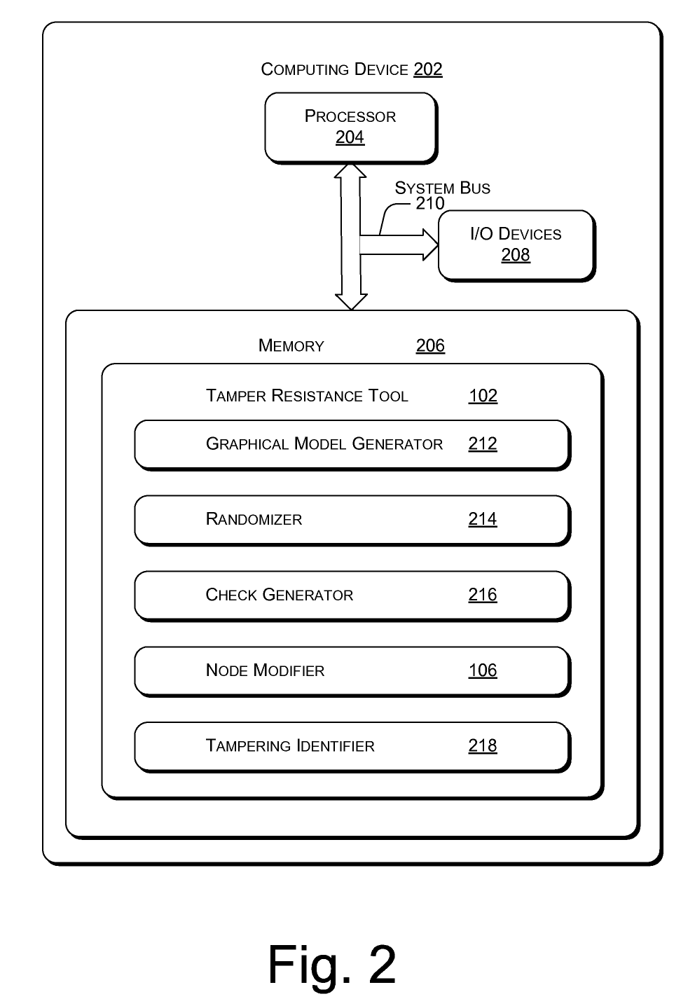

FIG. 2 illustrates a computing device including an exemplary tamper resistance tool.

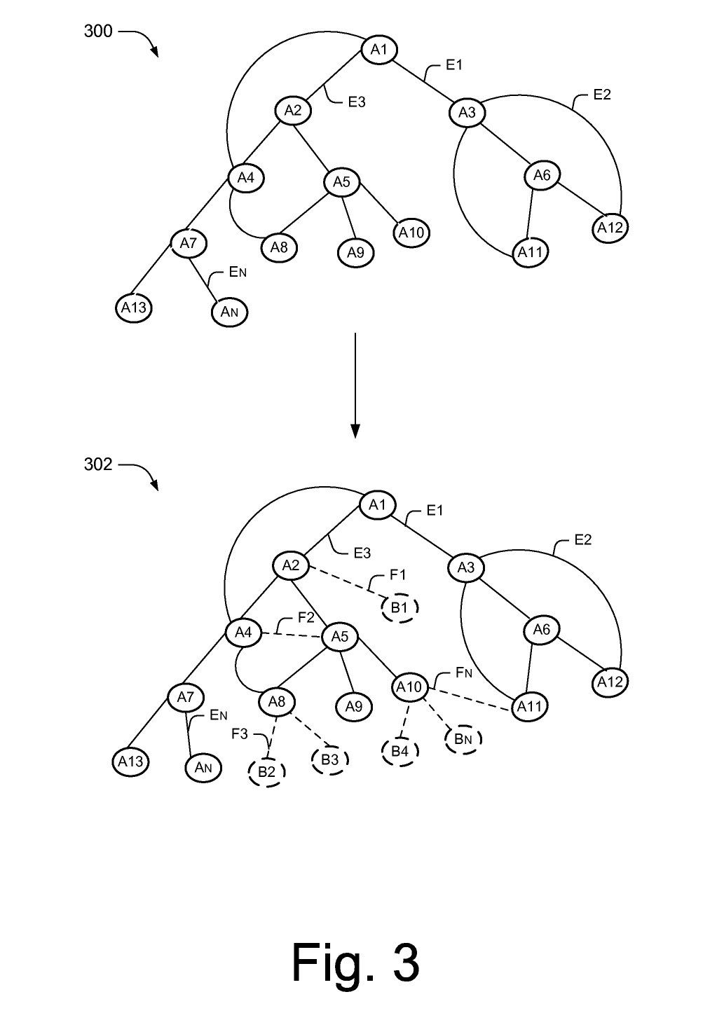

FIG. 3 illustrates an exemplary technique for randomization of paths of execution of a program.

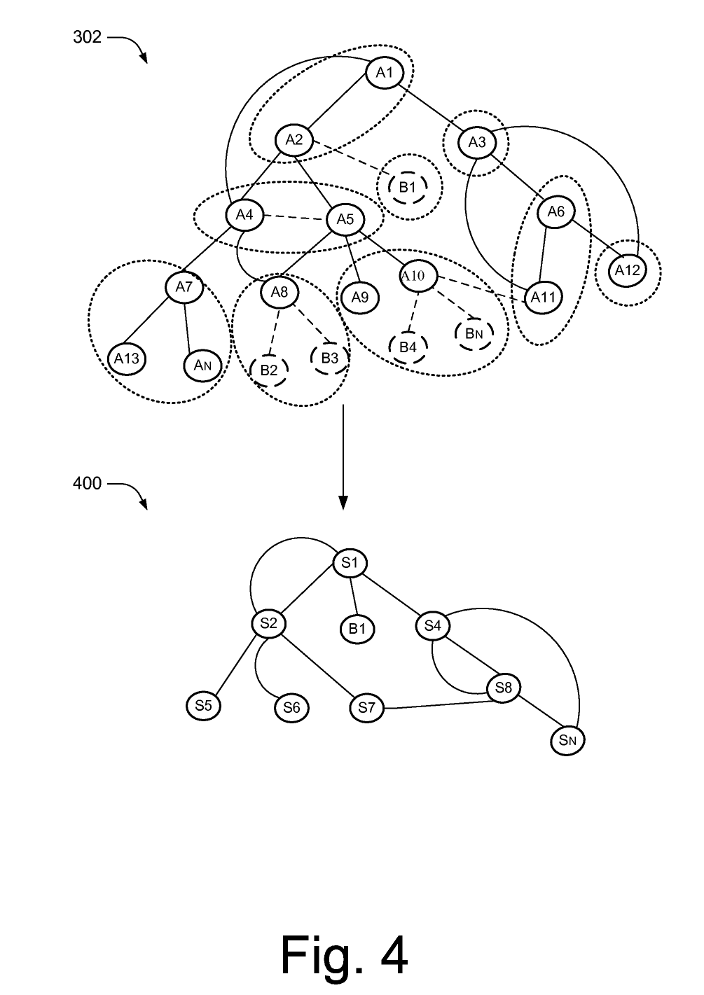

FIG. 4 illustrates another exemplary technique for randomization of paths of execution of a program.

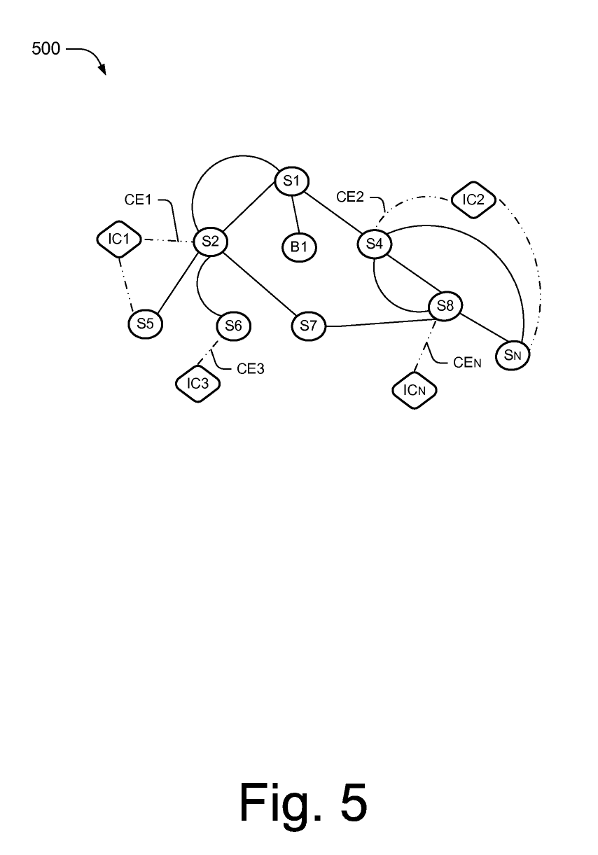

FIG. 5 illustrates an exemplary technique for inserting checking edges and integrity checks into a graphical representation.

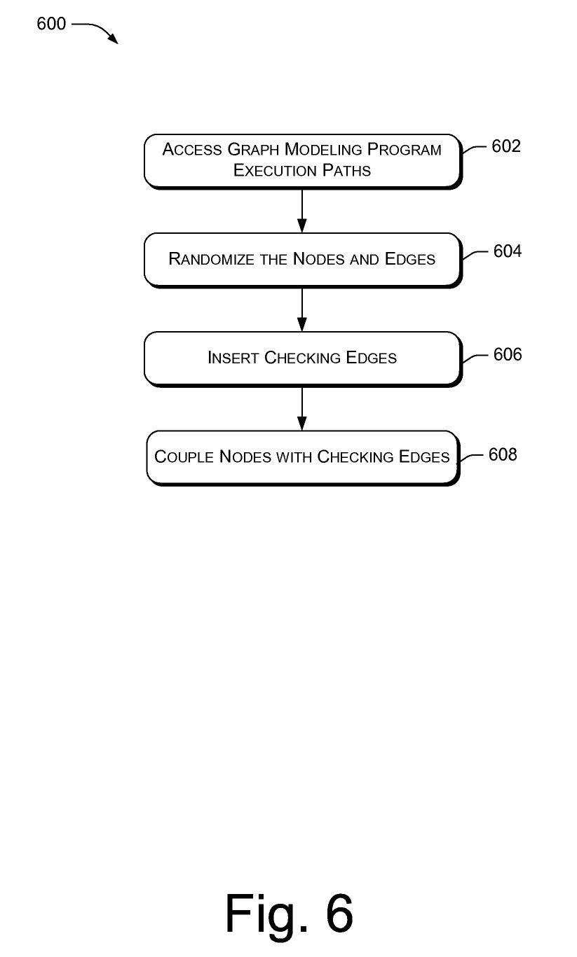

FIG. 6 illustrates an exemplary process for graph-based tamper resistance modeling for software protection.

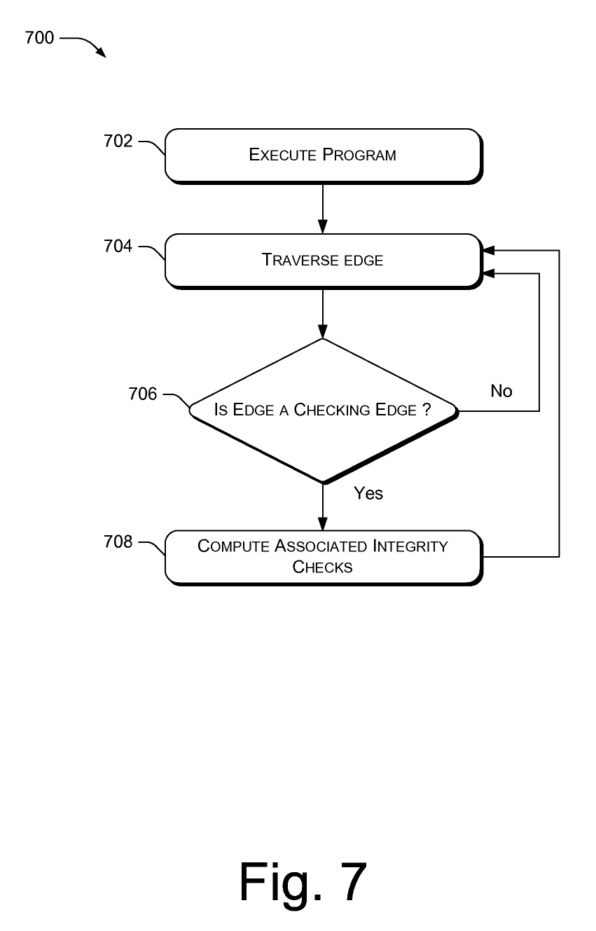

FIG. 7 illustrates an exemplary process of traversing a checking edge during program execution.

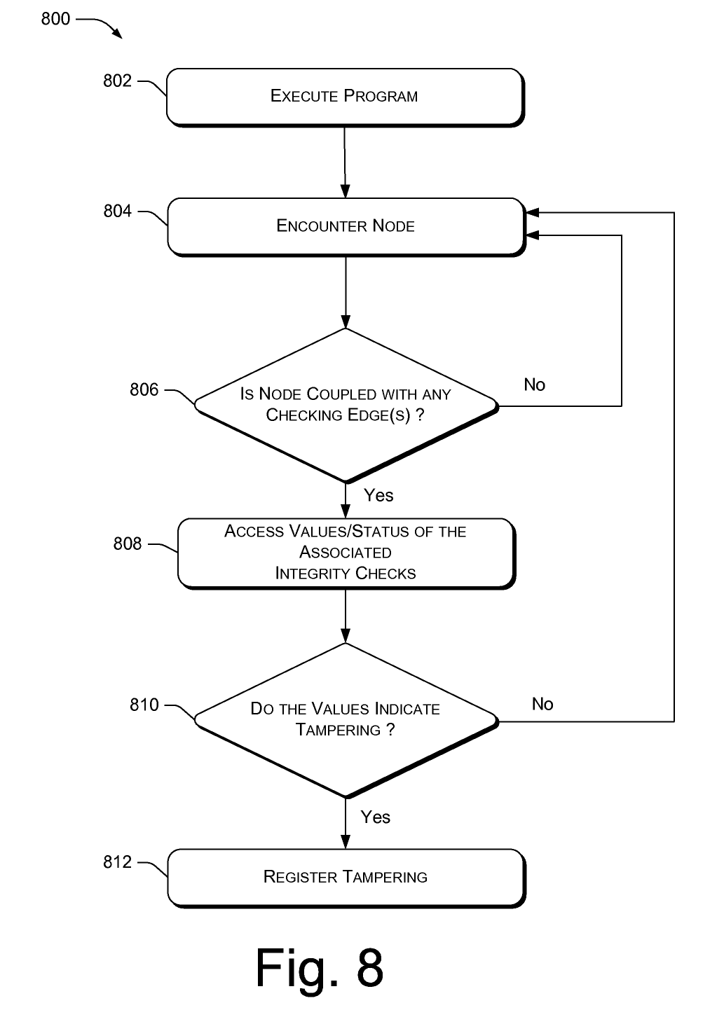

FIG. 8 illustrates an exemplary process of traversing a node coupled with checking edges during program execution.

### DETAILED DESCRIPTION

This disclosure is directed to techniques for implementing graph-based tamper resistance modeling for software protection. More particularly, the techniques described herein involve modeling paths of execution of a program as a graph and using integrity checks to detect tampering with the program. In one implementation, program execution is represented as a walk on the graph (e.g., a random or semi-random walk); critical sets of integrity checks are associated with graph nodes, and tamper responses are initiated if checks in these critical sets of integrity checks fail.

The techniques described herein also provide an analyzable tamper resistance model for the program by making it possible to estimate the minimum time that an attacker would require to undermine security features of the program based on the quantity and/or placement of the integrity checks in the program.

### Exemplary Environment

FIG. 1 shows an exemplary environment 100 suitable for implementing graph-based tamper resistance modeling for software protection. Environment 100 includes a tamper resistance tool 102 configured to impart tamper resistance functionality to an input code 104. In one configuration, tamper resistance tool 102 uses a node modifier 106 to produce tamper-resistant code 108 by injecting integrity checks into input code 104.

Tamper resistance tool 102 may be stored wholly or partially on any of a variety of computer-readable media, such as random access memory (RAM), read only memory (ROM), optical storage discs (such as CDs and DVDs), floppy disks, optical devices, flash devices, etc. Further, tamper resistance tool 102 can reside on different computer-readable media at different times.

Tamper resistance tool 102 may be implemented through a variety of conventional computing devices including, for example, a server, a desktop PC, a notebook or portable computer, a workstation, a mainframe computer, an Internet appliance, and so on.

In one implementation, tamper resistance tool 102 receives input code 104 from devices (such as storage devices or computing devices) coupled to a computing device implementing tamper resistance tool 102. Input code 104 may be a complete program or a part of a program that is to be provided with tamper resistance functionality. Input code 104 may also include conventionally used program code for software protection, as well as data associated with execution of program code. In addition, input code 104 can be received by tamper resistance tool 102 in a variety of forms, including as lines of program code (e.g., source), and/or as a graph representing paths of execution of lines of program code.

When tamper resistance tool 102 receives input code 104 as lines of program code, tamper resistance tool 102 can generate a graph representing the paths of execution of the lines of program code. Such a graph can include a plurality of nodes and edges, with each node in the graph representing a basic block, such as a straight-line piece of code without any internal jumps or jump targets. The edges in the graph may be used to represent jumps or changes in the paths of execution.

Tamper resistance tool 102 may randomize the paths of execution of input code 104 in the graph to obfuscate input code 104. Various obfuscation techniques known in the art can be used to accomplish this randomization. Some of these techniques will be discussed in more detail in conjunction with FIGS. 3 and 4 below.

Tamper resistance tool 102 can further alter the graph by inserting one or more checking edges into the graph. The checking edges can be associated with one or more integrity checks, such that when tamper-resistant code 108 is executed, and a checking edge is traversed, values of the integrity checks associated with the checking edge are computed. The computation of integrity check values can be indistinguishable from other operations of tamper-resistant code 108. In one implementation, the association of integrity checks with checking edges can be done by node modifier 106, with the resulting program code and/or data being tamper-resistant code 108. Insertion of checking edges and integrity checks into a graph will be discussed in more detail in conjunction with FIG. 5 below.

Once computed, the values of integrity checks can be stored in a memory location associated with the integrity checks, or they can be communicated to, for example, a processor or memory remote from the integrity checks. Values for integrity checks associated with a particular section of tamper-resistant code 108 can be called and examined at any time during program execution. In this way, it can be verified if the particular section of tamper resistant code 108 was executed without code or data tampering during a given time interval.

If the values of the integrity checks associated with the checking edge indicate tampering with tamper-resistant code 108, tamper resistance tool 102 can issue one or more responses, such as, termination of the execution of tamper-resistant code 108, degradation of the execution of tamper-resistant code 108, unreliable execution of tamper-resistant code 108, the issuance of an error message, and so on.

Since values for integrity checks associated with a particular section of tamper-resistant code 108 can be called and examined at any time during program execution, the response to a failed integrity check can occur after the activity which resulted in the failed integrity check. In this way, a cause-effect link between the activity resulting in the failed integrity check and the resulting responses issued by tamper resistance tool 102 can be masked in time and space.

### Exemplary Computing Device

FIG. 2 illustrates various components of an exemplary computing device 202 suitable for implementing tamper resistance tool 102. Computing device 202 can include a processor 204, a memory 206, input/output (I/O) devices 208 (e.g., keyboard, display, and mouse), and a system bus 210 operatively coupling various components of computing device 202.

System bus 210 represents any of several types of bus structures, including a memory bus or memory controller, a peripheral bus, an accelerated graphics port, and a processor or local bus using any of a variety of bus architectures. By way of example, such architectures can include an industry standard architecture (ISA) bus, a micro channel architecture (MCA) bus, an enhanced ISA (EISA) bus, a video electronics standards association (VESA) local bus, a peripheral component interconnects (PCI) bus also known as a mezzanine bus, a PCI express bus, a universal serial bus (USB), a secure digital (SD) bus, or an IEEE 1394 (i.e., FireWire) bus.

Memory 206 can include computer-readable media in the form of volatile memory, such as RAM and/or non-volatile memory, such as ROM, or flash RAM. Memory 206 can include data and program modules for implementing graph-based tamper resistance modeling for software protection, which are immediately accessible to and presently operated on by processor 204.

In one embodiment, memory 206 includes tamper resistance tool 102. Tamper resistance tool 102 can include a graphical model generator 212, a randomizer 214, a check generator 216, node modifier 106, and a tampering identifier 218.

Graphical model generator 212 can generate a graph representing paths of execution of input code 104 received by tamper resistance tool 102. Graphical model generator 212 can generate the graph using any method known in the art, and the graph can be a control flow graph, a data flow graph, or a combination of the two. Moreover, the graph can include a plurality of nodes connected by edges, with each node in the graph representing a basic block of input code 104, such as a straight-line piece of programming code in input code 104 without any internal jumps or jump targets.

The nodes in the graph may be combinations of one or more different types of nodes, such as operational nodes, call nodes, control nodes, and storage nodes. Operational nodes conduct arithmetic, logical, and relational operations, whereas call nodes denote calls to sub-program modules. Control nodes perform operations such as conditional processes and loop constructs, and storage nodes represent assignment operations associated with variables.

The edges in the graph represent movement of data and/or control of execution of input code 104 from one part of input code 104 to another. The edges may thus be used to represent jumps or changes in paths of execution of input code 104.

In one implementation, input code 104 can be obfuscated. This can be done by randomizer 214, which randomizes the paths of execution of input code 104 displayed in the graph. Randomization of the graph may be realized through a variety of obfuscation techniques known in the art, including the insertion of chaff nodes and chaff edges corresponding to the execution of inconsequential lines of code into the graph, the formation of super nodes by clustering two or more nodes in the graph, and so on. Randomization techniques which can be relied on by randomizer 214 will be discussed in more detail in conjunction with FIGS. 3 and 4 below.

The graph representing the paths of execution of input code 104—whether randomized by randomizer 214 or not—can be subjected to tamper resistance functionalities, transforming input code 104 into tamper-resistant code 108. For example, check generator 216 can insert both integrity checks and checking edges into the graph of input code 104. In one implementation, check generator 216 can associate each checking edge inserted into the graph of input code 104 with one or more integrity checks. Alternately, check generator 216 can associate one or more checking edges inserted into the graph of input code 104 with dummy integrity checks.

Check generator 216 can also associate one or more checking edges with selected nodes in the graph of input code 104. In this way, once a selected node is traversed during program execution, the one or more associated checking edges associated with the node are traversed and the integrity checks associated with the checking edge(s) are computed.

Computation of the integrity checks results in values for the integrity checks, which can immediately be accessed and viewed, or which can be stored and accessed during a later stage of program execution. Values for the integrity checks can be stored with the integrity checks themselves, or the values can be stored remote from the integrity checks.

Integrity checks may be generated by any method known in the art, including, for example, oblivious hashing, etc. For example, in one embodiment, integrity checks corresponding to a particular code section of input code 104 may compute a hash value or check sum value of a current program state. In one implementation, the hash value may be computed by computing a hash value of variables in the program at runtime, given specific inputs to the program. The computed hash values can be compared with pre-computed values to determine whether any tampering with the particular code section of input code 104 has occurred.

The integrity checks inserted into the graphical representation can be called at anytime during program execution, and the values for the integrity checks can be used to verify that a particular code section has been executed without code or data tampering during a given time interval. Techniques for the insertion of checking edges and integrity checks into the graph which can be used by check generator 216 will be discussed in more detail in conjunction with FIG. 5 below.

In one implementation, the values of the integrity checks are accessed after the integrity checks have been calculated. For example, node modifier 106 can create tamper-resistant code 108 from input code 104 by coupling nodes in the graph of input code 104 with checking edges inserted into the graph by check generator 216. Coupling can be done, for example, through use of mechanisms such as pointers at the node directing execution of tamper-resistant code 108 to an address of the checking edge coupled with the node.

Node modifier 106 can couple any combination of nodes with checking edges in this manner. This includes omitting one or more nodes from being coupled to checking edges. Further, node modifier 106 can couple nodes with more than one checking edge. In this way, once such a coupled node is arrived at during program execution, values of the integrity checks associated with the checking edges coupled to the node may be accessed.

Node modifier 106 can also include one or more integrity checks associated with a checking edge into a critical set of integrity checks for the checking edge. Failure of the critical set can indicate tampering with a section of tamper-resistant code 108 associated with the checking edge. The integrity checks included in the critical set can be predetermined by, for example, a user.

Accessing values of the integrity checks associated with the checking edges coupled to a node can be instigated by tampering identifier 218. In FIG. 2, tampering identifier is illustrated as residing within tamper resistance tool 102. It will also be understood, however, that tampering identifier 218 may reside at one or more of several different locations, including outside of tamper resistance tool 102.

For example, in one implementation, tampering identifier 218 may reside within tamper resistant code 108 at lines of code represented by nodes in the graph. In such an implementation, instructions associated with tampering identifier 218 can include commands to access the values of the integrity checks associated with a checking edge coupled with the node.

Alternately, tampering identifier 218 may exist apart from a node coupled with a checking edge. In such an implementation, tampering identifier 218 may be called through use of mechanisms such as a pointer at a node reached during program execution. The pointer could indicate a memory location at which tampering identifier 218 resides.

In operation, when program execution arrives at a node coupled with one or more checking edges, the values of the integrity checks associated with the checking edges are accessed. In one implementation, tampering identifier 218 accesses the values.

In another implementation, the node itself can access the values and pass the values on to tampering identifier 218.

As discussed above, values for integrity checks computed earlier during program execution may be stored with the integrity checks themselves, or the values may be stored remotely from the integrity checks. Similarly, if no value has been computed for an integrity check (i.e. the node associated with a checking edge associated with the integrity check has not yet been traversed during program execution), either the node coupled to the checking edge or tampering identifier 218 may instigate computation of the value of the integrity check associated with the checking edge.

Tampering identifier 218 can examine the accessed values of the integrity checks and register tampering based on the number of integrity checks that have failed. Failure of an integrity check can occur when the value of the integrity check computed during program execution fails to match a pre-computed, or baseline value for the integrity check.

In one implementation, tampering is registered at a node if one or more of the integrity checks associated with the checking edges coupled with the node fail. In another implementation, tampering is registered if a pre-set number of integrity checks fail. In yet another implementation, tampering is registered if all the integrity checks—such as a critical set—associated with a node fail. Moreover, the minimum number of integrity checks that are required to fail before tampering is registered can be varied by changing the number of checking edges coupled to a node.

Once tampering identifier 218 registers tampering, one or more responses may be initiated by tampering identifier 218. For example, the execution of tamper-resistant code 108 can be terminated. Alternately, tamper-resistant code 108 may be unreliably executed, or the execution of tamper-resistant code 108 may be degraded. In yet another implementation, an error message may be displayed.

It will be understood that the number of integrity checks required to fail in order to register tampering may vary depending upon the extent of separation desired between the actual tampering and the registration of tampering. In one embodiment, the minimum number of integrity checks that are required to fail is determined based upon a user input. For example, when tamper resistance tool 102 receives input code 104, tamper resistance tool 102 can request a user to specify obfuscation parameters. The obfuscation parameters can be used to determine either the number of checking edges that can be coupled to a node and/or the minimum number of integrity checks that are required to fail to register tampering. In another embodiment, tamper resistance tool 102 decides at random the number of checking edges that can be coupled to a node and/or the minimum number of integrity checks that are required to fail before tampering is registered.

It will also be understood that randomization may occur at any time to the graph representing the paths of execution of input code 104 and the graph representing the paths of execution of tamper-resistant code 108. For example, after the creation of tamper resistant code 108, randomizer 214 may randomize paths of execution in the tamper-resistant code 108 for greater obfuscation. Moreover, randomization of the paths of execution in the tamper-resistant code 108 can occur even if the graph representing the paths of execution of input code 104 has not been randomized. Randomization of the program graph may also occur at runtime (e.g., via self-modifying or so-called metamorphic code).

Alternately, both the graph representing the paths of execution of input code 104 and the graph representing the paths of execution of tamper-resistant code 108 can be randomized. Similarly, either or both of the graph representing the paths of execution of input code 104 and the graph representing the paths of execution of tamper-resistant code 108 can be randomized in successive iterations. The extent of randomization can be based upon obfuscation parameters specified by a user. Alternately, the extent of randomization can be preprogrammed or generated automatically.

It will also be understood that the various graphs representing paths of execution of input code 104 and tamper-resistant code 108 may be stored at various memories, including memory 206. Additionally, the various graphs may be stored at various memories at various times, or portions of the graphs may be stored across various memories.

### Estimating Minimum Attack Time

The quantity and/or placement of the integrity checks into the graph can be used to estimate the minimum time (i.e. a lower bound on a number of observations and modifications on tamper resistant code 108) that an attacker would require to undermine security features of tamper-resistant code 108. In one possible implementation, this estimation can be calculated by, for example, node modifier 106, tampering identifier 218, or a combination thereof.

For example, tamper resistant code 108 can be modeled to provide tamper resistant code 108 with polynomial and/or super-linear security. In one implementation, polynomial security can be quadratic security, i.e., the effort to break tamper resistant code 108 would increase quadratically in relation to the number of integrity checks inserted into tamper resistant code 108.

In one embodiment, tampering efforts can be modeled as a game in which an attacker makes a lower bound number of game steps to learn and break the protection of tamper resistant code 108 (referred to as program P below).

The model is based on a tamper resistance algorithm including:
1. Local indistinguishability: Program P can be transformed into a semantically equivalent program P¹ so that small windows of code all look alike. Iterated and randomized obfuscation can help achieve local indistinguishability.
2. Limited memory: An attacker has limited memory resources available.
3. Random flowgraph: Program P can be transformed into P¹ whose flowgraph G¹ includes random structures which cannot be easily separated from the original flowgraph G corresponding to P.

4. Graph-based attack: An attack proceeds by a graph game played on flowgraph G¹ of protected program P¹. An attacker runs or debugs P¹ and this process is modeled as walking on flowgraph G¹. In each step the attacker can either:
1. Follow a program transition and observe it; or
2. Change some data or code and observe the resulting transition.

If the attacker follows a program transition of code, it is assumed that the transition looks random to the attacker and no tampering has occurred. If the attacker changes data or code, then it is assumed that tampering has occurred and can be detected using integrity checks. Further, G¹ includes some secret random structure Γ which corresponds to the protection scheme. When tampering is detected, the protection responds in some way observable to the attacker by affecting execution of the program. The attacker wins the game if the secret structure Γ is discovered. The tamper resistance algorithm can be designed to provide a lower bound to the number of steps needed for the attacker to discover the secret structure Γ.

In the algorithm, paths of execution of the program are modeled as a graph with nodes representing basic blocks and edges representing possible transfers between basic blocks (i.e. branches and jumps). Randomization and clustering can be performed on this graph such that edges in the clustered graph still represent possible transfers, now between clusters of basic blocks. Further, integrity checks are generated and inserted in the graph to enable tamper-detection. Execution of the program is then abstracted as a walk on this graph.

The graph can be represented as G=(VE), where V represents the nodes and E represents the edges. Any choice of s distinct checking edges (i.e., edges associated with integrity checks) is called an s-arrangement, where s ε N. Check assignment, corresponding to coupling nodes with checking edges, is represented a function F:V→E^{s}, which assigns an s-arrangement to nodes at random. F(v) is thus the critical set of v. Thereby, the graph G=(V,E) can be transformed into a protected tamper-resistant graph G¹=((V,E), F) with a set of checks C⊂E.

Tamper detection and response mechanisms are embedded in the protected program, and implementation of the mechanisms depends on an instance key K corresponding to obfuscation parameters. Tamper detection and response mechanisms include a node v and its critical set F(v). Each edge e ε F(v) locally detects tampering and securely stores the result. If at v it is found that all edges, or at least a pre-set number of edges, of F(v) have been tampered with, then the program executes improperly. Association between v and F(v) can be implemented through transformations randomized using key K, so that patching one instance does not help patch another one, unless all instances of F(v) are discovered. For example, an integrity check may fail unless some hash function keyed with K evaluates to a preset value. Then patching a check e in an instance G_{K} can ensure that nodes which verify e now operate properly. But the same patch may not work for a different instance G_{K}¹.

The tamper resistance algorithm can be written as follows:

Protect (P, K, r, s) :
compute the flowgraph G₁ = (V₁,E₁) of P
use clustering, dummy call addition etc.
to get low-degree regular G = (V,E)
generate random function F : V → E^{s} using seed r
for each v ∈ V do
for each e ∈ F(v) do
create - check (K, e)
create - dependencies (K, v, F(v) )
output G
create - check (K, e = (u, v) ) :
change u and v so that :
1 . they identify to each other when calling via e
2 . if a call via e is detected and tampering flag T is set
then set A[e] = 1
these changes to u and v are randomized using K
create - dependencies (K, v, X) :
change v so that :
if A[e] = 1 for all e ∈ X
then run improperly in some way
the changes are randomized using K

When an attacker first executes a protected program, executing some portion of the protected program would yield unpredictable results. But the attacker can experiment with various inputs and learn how to make predictable changes. By executing some node, possibly multiple times with various changes, the attacker can learn how to break the protected program

Steps taken by the attacker can be modeled as a game in which, the attacker is presented with a graph (G, F) corresponding to a protected program and a single button. G can be chosen as a constant-degree expander graph with n nodes, dn edges, and second eigenvalue no bigger than a half degree. Check assignment F can be chosen randomly (i.e. each critical set F(v) can be obtained by independently choosing s distinct edges). The game can be played in rounds, a new round beginning when the attacker pushes the button.

In each round, program execution can be initiated as a random walk starting at a random node. The walk can go on until tamper-response is initiated. Once tamper response is initiated, the attacker is given the sequence of traversed edges. The attacker can then either start a new round, or try to guess F(v). The attacker wins by breaking the protected program, i.e., by guessing F(v) correctly.

A walk on the graph G can be represented as W, with L(W) denoting length of the walk (i.e. the number of edges traversed), and C(W) denoting coverage of the walk (i.e. number of distinct edges traversed). Further, walk W¹ can be considered to be a segment of walk W if W¹ appears in W as a contiguous sequence of traversed edges. Further, it can be proven that for each n there is s so that for at least 1−O(n⁻²) fraction of check assignments, winning the above game requires Ω(n²) steps, except with probability 2/(ₛ^{dn}). Thus the total number of steps to be executed by an attacker to break a protected program can be no less than quadratic.

For example, suppose walks W₁ . . . W_{n/2} are observed. It can be proven that (except with small probability):
Part 1. At least half of the observed walks have lengths at least within constant of n. The total number of steps will thus be no less than quadratic.
Part 2. There is at least one node v for which F(v) “remains hidden” with O(n⁻²) probability: there is a set Ψ of (ₛ^{dn})/2 check assignments consistent with the observed walks, and these check assignments differ only in their choice of critical set of v.

It will also be understood that if crashes are not deterministic in the game, when a node v (whose critical set F(v) is activated) is encountered in the walk, then a crash occurs with probability p. It can be then assumed that walks on G are augmented with these random decisions of nodes. An augmented walk of length l is thus an element of (Ex{0, 1})¹. Thus a previous game can be seen as a restriction of this non-deterministic one, with p=1.

Therefore, checks and responses (such as crashes) can be made probabilistic as a means of increasing security. User-specified parameters and/or automatic processes and analysis can determine the associated probabilities, which may vary at runtime.

### Exemplary Randomization Techniques

FIGS. 3 and 4 illustrate exemplary techniques for randomization of the paths of execution of a program, such as input code 104 and tamper-resistant code 108. Such techniques can be used to randomize the paths of execution of a program at any stage in the processing of the program, including before and after tamper-resistant functionalities have been added to the program.

FIG. 3 provides a graph 300 representing paths of execution of a program. Nodes A1, A2 . . . A_{N} correspond to one or more lines of code in the program associated with a given functionality. Each node A1-A_{N} in graph 300 represents a basic block of the program, such as a straight-line piece of code without any internal jumps or jump targets. Edges E1, E2 . . . E_{N} connecting nodes A1-A_{N} represent jumps or changes in the paths of execution of the program.

In one implementation, randomization may be achieved by adding extra nodes and edges, referred to as chaff nodes and chaff edges, corresponding to the execution of inconsequential lines of code. The inconsequential lines of code may be either duplicates of existing lines of code or other inert lines of code having no semantic effect on the execution of the program. Chaff code may also temporarily corrupt and restore program variables and state, mainly to appear tightly integrated into the program.

For example, as shown in FIG. 3, a randomized graph 302 representing the paths of execution of the program may be created by randomizing graph 300 through the introduction of chaff nodes B1, B2 . . . B_{N} and/or chaff edges F1, F2 . . . F_{N}. Chaff nodes B1, B2 . . . B_{N} and chaff edges F1, F2 . . . F_{N} are well integrated in graph 302 and their execution is indistinguishable from the execution of other nodes and edges in graph 302.

FIG. 4 illustrates another technique of implementing randomization—the clustering of two or more sub nodes in a sub graph to form a super node. For purposes of illustration, graph 302 can be treated as a sub graph, and the nodes and edges in graph 302 can be treated as sub nodes and sub edges.

As illustrated in FIG. 4, selected sub nodes from nodes A1, A2 . . . A_{N} and chaff nodes B1, B2 . . . B_{N} of graph 302 may be clustered to form super nodes S1, S2 . . . S_{N} in graph 400. For instance, nodes A1 and A2 in graph 302 may be clustered to form super node S1 in graph 400. Alternately, node A8 can be clustered with chaff nodes B2 and B3 to form super node S6.

In this manner, two or more sub nodes taken from the set of nodes A1, A2 . . . A_{N} and chaff nodes B1, B2 . . . B_{N} of graph 302 can be clustered to form any number of super nodes in graph 400. As also shown, however, all of the nodes A1, A2 . . . A_{N} and B1, B2 . . . B_{N} of graph 302 need not be clustered. For example, chaff node B1 exists unchanged in graph 400, though chaff node B1 is connected to super node S1 in graph 400 rather than being connected to node A2 as chaff node B1 was in graph 302.

### Exemplary Checking Edge and Integrity Check Insertion Technique

FIG. 5 provides a graph 500 representing paths of execution of a program in which checking edges and integrity checks have been inserted. Buy way of explanation, graph 500 has been created from graph 400. As noted above, however, checking edges and integrity checks can be inserted into graphs where no randomization has been carried out (such as graph 300). Alternately, checking edges and integrity checks can be inserted into graphs where various levels of randomization have been carried out, including graphs created using processes different than those used to arrive at graph 400.

As shown, checking edges CE1-CE_{N} are associated with selected nodes from nodes S1-S_{N} in graph 500. For example, checking edge CE1 is associated with node S2. Similarly, checking edge CE2 is associated with node S4. Moreover, checking edge CE3 is associated with node S6, and checking edge CE_{N} is associated with node S8.

Graph 500 illustrates a subset of nodes S1-S_{N} as being associated with checking edges CE1-CE_{N}. It will be understood, however, that more or fewer nodes S1-S_{N} on graph 500 can be associated with checking edges CE1-CE_{N}. Moreover, individual nodes S1-S_{N} on graph 500 can be associated with more than one checking edge. For example, checking edge CE1 could be associated with more checking edges than just node S2.

In addition to being associated with nodes, checking edges CE1-CE_{N} are also associated with one or more integrity checks IC1-IC_{N}. For example, checking edge CE1 is associated with integrity check IC1. Similarly, checking edge CE2 is associated with integrity check IC2, checking edge CE3 is associated with integrity check IC3, and checking edge CE_{N} is associated with integrity check IC_{N}. Each integrity check IC1-IC_{N} can include one or more integrity checks, including checks utilizing oblivious hashing, or any other integrity checking method known in the art.

In one implementation, when a node associated with a checking edge is traversed during program execution, values for the integrity checks associated with the checking edge are computed. For example, if node S2 is traversed during program execution, values for integrity checks IC1 associated with checking edge CE1 are computed. In a similar manner, values for other integrity checks IC1-IC_{N} are computed when nodes with which they are associated are traversed during program execution. These values can be stored at the integrity checks themselves, or at memory locations associated with the integrity checks. Alternately, the values may be sent to memory locations remote from the integrity checks.

In addition to being associated with checking edges CE1-CE_{N}, nodes S1-S_{N} in graph 500 can also be coupled to checking edges CE1-CE_{N}. For example, node S7 can be coupled to checking edge CE1. Thus, when program execution traverses node S7, the values of integrity checks IC1 associated with checking edge CE1 can be accessed and compared to pre-computed or baseline values for integrity checks IC1. If the computed values of integrity checks IC1 differ from the pre-computed or baseline values for integrity check IC1, integrity checks IC1 can be said to have failed, and tampering of the program underlying graph 500 can be inferred.

Nodes S1-S_{N} can be coupled to one or more checking edges CE1-CE_{N}. Moreover, nodes S1-S_{N} can be coupled to the same checking edges CE1-CE_{N} with which nodes S1-S_{N} are themselves associated.

### Exemplary Processes

FIG. 6 illustrates an exemplary process 600 for graph-based tamper resistance modeling for software protection. Process 600 is illustrated as a collection of blocks in a logical flow graph representing a sequence of operations that can be implemented in hardware, software, firmware or a combination thereof. The order in which the method is described is not intended to be construed as a limitation, and any number of the described method blocks can be combined in any order to implement the method, or an alternate method. Additionally, individual blocks may be deleted from the method without departing from the spirit and scope of the subject matter described herein.

In the context of software, the blocks represent computer instructions that, when executed by one or more processors, perform the recited operations. For discussion purposes, the process 600 is described with reference to environment 100 shown in FIG. 1, tamper resistance tool 102 shown in FIG. 2, and the various graphs and elements shown in FIGS. 3-5

At block 602, a graph representing paths of execution of a program is accessed. The graph may be received as program code, such as input code 104, or the graph may be generated by a tool, such as tamper resistance tool 102, based on the program code.

At block 604, the paths of execution in the graph may be randomized to obfuscate the program code from which the graph was constructed. In one implementation, randomization can be done by randomizer 214. Randomization of the paths of execution may be realized by using one or more of any techniques known in the art. For example, randomization can be implemented by inserting nodes and edges, such as chaff nodes and chaff edges, corresponding to the execution of inconsequential lines of code into the graph. As another example, chaff code may be implemented via opaque predicates. Additionally, the graph can be randomized by forming nodes, such as super nodes S1-S_{N}, by clustering together nodes in the graph.

At block 606, checking edges are inserted into the graph. In one implementation, this can be accomplished by check generator 216. The checking edges are associated with one or more integrity checks and one or more nodes in the graph. The integrity checks may be generated by any method known in the art, such as oblivious hashing, etc. The integrity checks can also be executed at runtime to verify that a particular code section was executed without being subjected to tampering of the program code or data associated with the program code. Execution of an integrity check can occur when a node associated with a checking edge (which checking edge is itself is associated with the integrity check) is traversed at runtime.

At block 608, one or more nodes are coupled with one or more checking edges such that when program execution traverses the nodes, values of the integrity checks to which the checking edges are associated are accessed to determine whether the program has been tampered with or not. In case the determination indicates tampering, a suitable tamper response may be initiated. In one possible implementation, nodes may be coupled to checking edges by node modifier 106.

FIGS. 7 and 8 illustrate processes that are carried out when program execution traverses a checking edge, and when program execution traverses a node coupled with a checking edge, respectively.

Processes 700 and 800 are illustrated as a collection of blocks in a logical flow graph representing a sequence of operations that can be implemented in hardware, software, firmware or a combination thereof. The order in which the methods are described is not intended to be construed as a limitation, and any number of the described method blocks can be combined in any order to implement the methods, or alternate methods. Additionally, individual blocks may be deleted from the methods without departing from the spirit and scope of the subject matter described herein.

In the context of software, the blocks represent computer instructions that, when executed by one or more processors, perform the recited operations. For discussion purposes, the processes 700 and 800 are described with reference to environment 100 shown in FIG. 1, tamper resistance tool 102 shown in FIG. 2, and the various graphs and elements shown in FIGS. 3-5.

At block 702, process 700 is initiated by executing tamper-resistant program code. The tamper-resistant program code can include, for example, tamper-resistant code 108.

At block 704, a new edge of the tamper-resistant code is traversed during program execution.

At block 706, the edge traversed at block 704 is examined to determine if the edge is a checking edge, such as edges CE1-CE_{N}. If the edge being traversed is not a checking edge (i.e. the “no” branch from block 706), process 700 can return to block 704, and the next edge traversed in the execution of the program can be examined.

Alternately, if the edge of the tamper-resistant code being traversed during program execution is determined to be a checking edge (i.e. the “yes” branch from block 706), then values of integrity checks associated with the checking edge can be computed at block 708. These values can be stored at the integrity checks themselves, or the values can be stored remotely from the integrity checks. Alternately, the values can be sent to a separate entity.

Once the values of the integrity checks associated with the checking edge are calculated, process 700 can return to block 704 where the next edge traversed in the program can be examined.

In FIG. 8, at block 802, execution of a tamper-resistant code is begun. The tamper-resistant program code can include, for example, tamper-resistant code 108.

At block 804, a node to be executed is encountered during program execution.

At block 806, the node encountered at block 804 is examined to determine if the node is coupled with a checking edge, such as CE1-CE_{N}. If the node is not coupled with a checking edge (i.e. the “no” branch from block 806), process 800 returns to block 804 and a next node to be executed during program execution can be examined.

Alternately, if the node to be executed during program execution is coupled with a checking edge (i.e. the “yes” branch from block 806), then values of integrity checks, such as integrity checks IC1-IC_{N}, associated with the checking edge are accessed at block 808. These values can have been computed previously during program execution. In one implementation, values of integrity checks are calculated when a checking edge associated with the integrity checks are traversed during program execution, such as was detailed in the discussion regarding process 700 above.

At block 810, the values accessed at block 808 are examined to determine if program code or data from the program being executed has been tampered with. In one implementation, the values accessed at block 808 are compared against pre-computed or baseline values. If an exact match is not found, then the integrity checks can be said to have failed. One or more or more failed integrity checks can be considered to indicate tampering.

If the values of the integrity checks accessed at block 808 do not indicate tampering (i.e. the “no” branch from block 810), then process 800 returns to block 804 where another node being traversed during program execution can be examined. Alternately, if the values of the integrity checks accessed at block 808 indicate tampering (i.e. the “yes” branch from block 810), then tampering is registered and one or more tamper responses can be initiated at block 812. For example, the execution of the tamper-resistant code can be terminated. Alternately, the tamper-resistant code can be unreliably executed, or the execution of tamper-resistant code can be degraded. In yet another implementation, an error message can be displayed.

### CONCLUSION

Although embodiments of graph-based tamper resistance modeling for software protection have been described in language specific to structural features and/or methods, it is to be understood that the subject of the appended claims is not necessarily limited to the specific features or methods described. Rather, the specific features and methods are disclosed as exemplary implementations of graph-based tamper resistance modeling for software protection.

What is claimed is:

1. A method comprising:
accessing a graph, wherein the graph models paths of execution associated with a program, and further wherein the graph includes a plurality of nodes and one or more edges;
inserting one or more checking edges into the graph, wherein the one or more checking edges are associated with selected nodes in the plurality of nodes, and further wherein the one or more checking edges are associated with one or more integrity checks; and
registering tampering with the program based upon detection of one or more failed integrity checks.

2. The method of claim 1 wherein accessing further comprises randomizing a sub graph including a plurality of sub nodes and one or more sub edges into the plurality of nodes and the one or more edges in the graph.

3. The method of claim 2, wherein randomizing includes one or more of:
adding one or more chaff sub nodes into the sub graph;
clustering two or more sub nodes into a node.

4. The method of claim 1 wherein accessing comprises creating the graph based on the program.

5. The method of claim 1, wherein inserting includes coupling one of the plurality of nodes with at least one of the one or more checking edges.

6. The method of claim 1, wherein registering includes detecting at least one of the one or more failed integrity checks after the one or more failed integrity checks have been calculated.

7. The method of claim 1, further comprising estimating a minimum attack time required to break protection of the program based on a number of integrity checks associated with the program.

8. The method of claim 1, further comprising determining that one of the one or more integrity checks has failed if a hash value of variables computed in the program at runtime in association with the integrity check does not exactly match a pre-computed hash value of the variables associated with the integrity check.

9. A computer-readable medium having a set of computer-readable instructions residing thereon that, when executed, perform acts comprising:
implementing execution of a program as a walk through a graph of the program, wherein the graph includes one or more nodes associated with integrity checks;
accessing a status of integrity checks coupled with at least one node of the one or more nodes; and
indicating that the program has been compromised when the status of the integrity checks indicates tampering with the program.

10. The computer-readable medium of claim 9, further comprising computer executable instructions that, when executed, perform acts comprising:
executing integrity checks associated with one node of the one or more nodes as execution of the program traverses the one node.

11. The computer-readable medium of claim 9, further comprising computer executable instructions that, when executed, perform acts comprising:
estimating a total number of actions to be executed by an attacker to defeat security features of the program as being one of:
a super-linear function of a number of integrity checks associated with the program;
a polynomial function of a number of integrity checks associated with the program.

12. The computer-readable medium of claim 9, further comprising computer executable instructions that, when executed, perform acts comprising:
executing an integrity check by computing a hash value of a current program state at runtime and comparing the hash value with a pre-computed hash value; and
returning a false value for the status of the integrity check when the hash value of the current program state at runtime fails to match the pre-computed hash value, wherein the false value indicates tampering with the program.

13. The computer-readable medium of claim 9, further comprising computer executable instructions that, when executed, perform acts comprising:
indicating that the program has been compromised by one of:
terminating the execution of the program;
degrading the execution of the program;
unreliably performing the execution of the program;
displaying an error message.

14. A computing device comprising:
a memory;
one or more processors operatively coupled to the memory;
a check generator configured to insert a plurality of checking edges in a graphical model of a program, wherein the graphical model includes a plurality of nodes and edges, and further wherein each checking edge is associated with one or more integrity checks;
a node modifier configured to couple one or more of the plurality of nodes with a subset of the checking edges; and
a tampering identifier configured to perform acts comprising:
determining a status of the integrity checks associated with one or more checking edges; and
regulating execution of the program depending upon the status of the integrity checks.

15. The computing device of claim 14, wherein the node modifier is configured to couple nodes to checking edges with which the nodes are not associated.

16. The computing device of claim 14, wherein the tampering identifier is configured to determine the status of an integrity check by comparing a pre-computed hash value of variables in the program against a hash value of the variables in the program computed at runtime.

17. The computing device of claim 16, wherein the tampering identifier is configured to return a false status for an integrity check when the pre-computed hash value of variables in the program fails to match the hash value of the variables in the program computed at runtime.

18. The computing device of claim 14, wherein the tampering identifier is configured to regulate execution of the program when at least a subset of the integrity checks fail.

19. The computing device of claim 14 further comprising a graphical model generator configured to generate the graphical model of the program.

20. The computing device of claim 14, further comprising a randomizer configured to randomize the plurality of nodes and edges by at least one of:
inserting chaff nodes into the graphical model;
inserting chaff edges into the graphical model;
clustering two or more nodes in the graphical model into a super node.
